(19) United States
(12) Patent Application Publication
(10) Pub. No.: US 2012/0027012 A1
(43) Pub. Date: Feb. 2, 2012

(54) COMMUNICATION DEVICE, COMMUNICATION SYSTEM, AND COMPUTER PROGRAM PRODUCT

(75) Inventor: Yasuhiro KUDO, Ichinomiya-shi (JP)

(73) Assignee: BROTHER KOGYO KABUSHIKI KAISHA, Nagoya-shi (JP)

(21) Appl. No.: 13/189,015

(22) Filed: Jul. 22, 2011

(30) Foreign Application Priority Data
Jul. 27, 2010 (JP) 2010-167736

(51) Int. Cl. H04L 12/56

(52) U.S. Cl. 370/389

(57) ABSTRACT

A communication device acquires a first condition in a case where a request packet requesting establishment of a communication path is received from a second communication device in a state in which a communication path with a first communication device is established. The first condition is a condition that is used to perform a session with the first communication device. Then the communication device transmits to the second communication device a response packet including the first condition acquired by the acquisition portion. In a case where a notification packet is received from the second communication device in response to the response packet, the communication device establishes a communication path with the second communication device to perform the session with the second communication device using the first condition.

### CROSS-REFERENCE TO RELATED APPLICATION

This application claims priority to Japanese Patent Application No. 2010-167736, filed Jul. 27, 2010, the disclosure of which is hereby incorporated by reference in its entirety.

### BACKGROUND

The present disclosure relates to a communication device, a communication system and a computer program product that perform call control communication between a plurality of communication devices using a session description protocol (SDP).

The session description protocol (SDP) is known as a protocol to establish a communication path between communication devices. In the SDP, a calling-side communication device transmits, to a called-side communication device, a request packet that stores offer information. Hereinafter, the calling-side communication device is hereinafter referred to as a calling device. The called-side communication device is hereinafter referred to as a called device. One or more pieces of media information that identify media that can be used by the calling device are stored in the request packet as the offer information. The media are, for example, audio and video codecs or the like. From the offer information stored in the received request packet, the called device selects the media information for the media that can be used by the called device. The called device stores the selected media information as answer information in a response packet and transmits the response packet to the calling device. The calling device uses the media identified by the media information that is stored as the answer information in the response packet. The calling device can establish a communication path with the called device and perform peer to peer (P2P) communication with the called device.

A case is assumed in which another communication device newly enters a video conference being performed between a plurality of communication devices. The communication device already participating in the video conference is hereinafter referred to as a “conference device.” The communication device newly entering the video conference is hereinafter referred to as the “entering device.” In this case, the entering device transmits a request packet storing offer information to the conference device. The conference device receives the request packet. The conference device selects, from the offer information, media information of media necessary to perform the video conference. The conference device stores the selected media information as answer information in a response packet and transmits the response packet to the entering device. By using the media identified by the media information stored as the answer information in the response packet, the entering device can enter the video conference.

### SUMMARY

It is assumed that a dedicated application for the video conference is used in the video conference that is underway. In addition, it is assumed that the media information stored as the offer information in the request packet transmitted from the entering device does not include media information that identifies the dedicated application. In this case, the conference device that receives the request packet does not notify the entering device by using the response packet that the dedicated application is being used. Even if the entering device refers to the answer information stored in the response packet, it cannot recognize the need for the dedicated application. As a result, even if the entering device can use the dedicated application, the entering device does not use the dedicated application. Thus, the entering device cannot establish a communication path with the conference device. As described above, when communication is performed based on the SDP, there may be a case in which the communication device that has established the communication path with the other communication device cannot establish the communication path with the newly entering other communication device.

Various exemplary embodiments of the general principles herein provide a communication device, a communication system, a communication method and a computer program product that are capable of reliably establishing a communication path with a newly entering other communication device in a state in which the communication device has established a communication path with another communication device.

Exemplary embodiments provide a communication device includes an acquisition portion that acquires a first condition in a case where a request packet requesting establishment of a communication path is received from a second communication device in a state in which a communication path with a first communication device is established, the first condition being a condition that is used to perform a session with the first communication device, the first communication device being another communication device that has established the communication path with the communication device, the second communication device being yet another communication device that has not established a communication path with the communication device, a first transmission portion that transmits to the second communication device a response packet including the first condition acquired by the acquisition portion, and an establishment portion that, in a case where a notification packet is received from the second communication device in response to the response packet transmitted by the first transmission portion, establishes a communication path with the second communication device to perform the session with the second communication device using the first condition, the notification packet notifying that the second communication device can perform the session by using the first condition.

Exemplary embodiments further provide a communication system includes a first communication device, a second communication device and a third communication device, wherein the first communication device includes an acquisition portion that acquires a first condition in a case where a request packet requesting establishment of a communication path is received from the third communication device in a state in which a communication path with the second communication device is established and a communication path with the third communication device is not established, the first condition being a condition that is used to perform a session with the second communication device, a first transmission portion that transmits a response packet including the first condition acquired by the acquisition portion to the third communication device, and a first establishment portion that, in a case where a notification packet is received from the third communication device in response to the response packet transmitted by the first transmission portion, establishes a communication path with the third communication device to perform the session with the third communication device using the first condition, the notification packet notifying that the third communication device can perform the session by using the first condition, and the third communication device includes a second transmission portion that transmits the request packet to the first communication device, a first determination portion that, in a case where the response packet returned from the first communication device is received in response to the request packet transmitted by the second transmission portion, determines whether the session can be performed using the first condition included in the response packet, a third transmission portion that, in a case where it is determined by the first determination portion that the session can be performed using the first condition, transmits the notification packet to the first communication device, and a second establishment portion that, after the notification packet is transmitted by the third transmission portion, establishes the communication path with the first communication device to perform the session with the first communication device using the first condition.

Exemplary embodiments further provide a computer program product stored on a non-transitory computer-readable medium includes instructions for causing a processor of a communication device to execute the steps of acquiring a first condition in a case where a request packet requesting establishment of a communication path is received from a second communication device in a state in which a communication path with a first communication device is established, the first condition being a condition that is used to perform a session with the first communication device, the first communication device being another communication device that has established the communication path with the communication device, the second communication device being yet another communication device that has not established a communication path with the communication device, transmitting a response packet including the acquired first condition to the second communication device, and establishing a communication path with the second communication device to perform the session with the second communication device using the first condition, in a case where a notification packet is received from the second communication device in response to the transmitted response packet, the notification packet notifying that the second communication device can perform the session by using the first condition.

### BRIEF DESCRIPTION OF THE DRAWINGS

Exemplary embodiments of the present disclosure will be described below in detail with reference to the accompanying drawings in which:

FIG. 1 is a diagram showing an overview of a communication system 1 and an electrical configuration of a communication device 12;

FIG. 2 is a diagram showing a communication sequence between the communication devices 12 and 13;

FIG. 3 is a diagram showing an example of information stored in a request packet (INVITE);

FIG. 4 is a diagram showing an example of information stored in a positive response packet (OK response);

FIG. 5 is a diagram showing a communication sequence between the communication devices 12, 13 and 14;

FIG. 6 is a diagram showing an example of information stored in a positive response packet (OK response);

FIG. 7 is a diagram showing an example of information stored in an ACK packet;

FIG. 8 is a flow chart showing calling-side processing;

FIG. 9 is a flow chart showing called-side processing; and

FIG. 10 is a flow chart showing shared processing of the calling-side processing and the called-side processing.

### DETAILED DESCRIPTION

Hereinafter, an embodiment of the present disclosure will be explained with reference to the appended drawings.

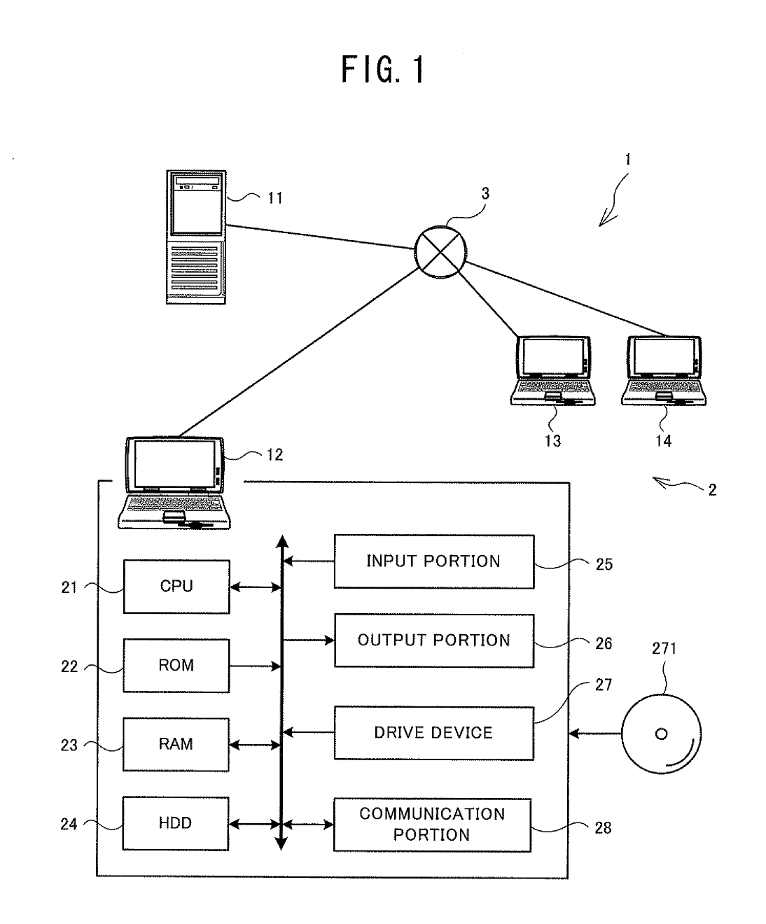

A communication system 1 will be explained with reference to FIG. 1. The communication system 1 is provided with a server 11 and communication devices 12, 13 and 14. Hereinafter, in a case where no distinction is made between the communication devices 12, 13 and 14 or in a case where the communication devices 12, 13 and 14 are referred to collectively, they are referred to as “communication device 2” or “communication devices 2.” The server 11 and the communication devices 2 can perform mutual communication via a network 3. Each of the communication devices 2 can establish a communication path with another of the communication devices 2 using call control communication. The communication device 2 may be, for example, a known personal computer (PC). Session initiation protocol (SIP) or session description protocol (SDP), for example, may be used as the call control communication protocol. The server 11 controls the call control communication between the communication devices 2. The server 11 may be a SIP server. In the present embodiment, a video conference is performed between the communication devices 2 after a communication path has been established between the communication devices 2. Hereinafter, performing call control communication such that a video conference can be performed is also referred to as “establishing a communication path.” A series of communications that are performed between the communication devices 2 at the time of the video conference is referred to as a “session.” For example, a communication device 2 first establishes a communication path with another communication device 2 through call control communication via the server 1. As a result, it becomes possible to perform a session between the communication device 2 and the other communication device 2 through the established communication path. Then the video conference can be performed by performing the session between the communication device 2 and the other communication device 2. An application that is executed after establishing the communication path is not limited to the application for the video conference. In the explanation that follows, the reference numerals attached to the communication devices 2 (12, 13 and 14) also indicate an ID of each of the communication devices 2.

An electrical configuration of the communication device 12 will be explained. An electrical configuration of the communication devices 13 and 14 is the same as that of the communication device 12. The communication device 12 is provided with a CPU 21 that controls the communication device 12. The CPU 21 is electrically connected to a ROM 22, a RAM 23, a hard drive disk (HDD) 24, an input portion 25, an output portion 26, a drive device 27 and a communication portion 28. A boot program, and a basic input output system (BIOS), an operation system (OS) and the like are stored in the ROM 22. Temporary data, such as a timer value and a counter value, are stored in the RAM 23. A communication program of the CPU 21 is stored in the HDD 24. The input portion 25 is a keyboard or a mouse that receives input from a user. The output portion 26 is a display on which an image is displayed. The drive device 27 can read out information stored in a storage medium 271. When the communication device 12 is set up, for example, a communication program stored in the storage medium 271 is read out by the drive device 27 and is stored in the HDD 24. The communication portion 28 performs timing control when the communication device 12 performs communication with another of the communication devices 2 or with the server 11, via the network 3.

The communication device 2 identifies, by SDP-based call control communication, the media that is used when the communication device 2 performs the video conference with another of the communication devices 2. Media may include, for example, audio and video codecs, and dedicated applications that are used when performing the video conference. Dedicated applications may include, for example, file sharing applications. By using the media identified by the SDP-based call control communication, the communication device 2 can smoothly establish a communication path with another of the communication devices 2 and perform the video conference.

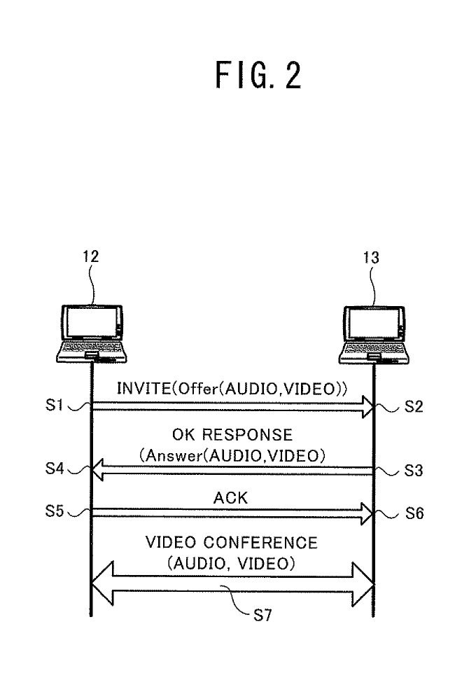

An example of call control communication based on the SDP will be explained with reference to FIG. 2. It should be noted that, although the call control communication is performed via the server 11, the server 11 is not shown in FIG. 2. It is here assumed that an input operation is performed on the communication device 12 to start a video conference with the communication device 13. The communication device 12 transmits, to the communication device 13 via the server 11, a request packet (INVITE) that requests establishment of a communication path with the communication device 13 (step S1). Media information of media that can be used by the communication device 12 and that is normally used in a session with the communication device 13 is stored in the request packet (INVITE). In FIG. 2, media information of media relating to audio and video is stored in the request packet (INVITE). In a case where there is a plurality of media information sorted by category of the media that can be used, the communication device 12 can store the plurality of media information in the request packet (INVITE). Hereinafter, the information stored in a packet as media information of media that can be used is referred to as “offer information.”

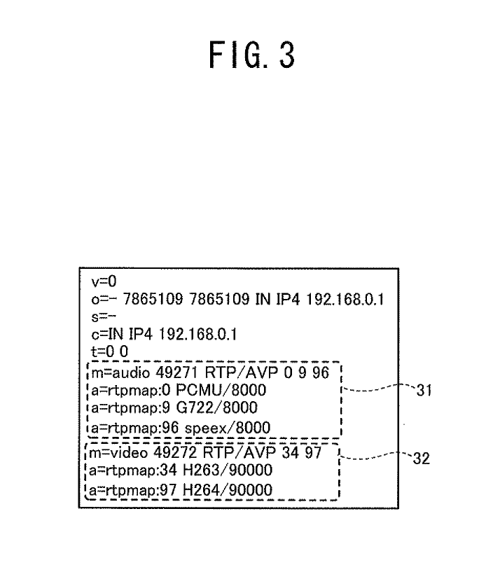

The information stored in the request packet (INVITE) transmitted at step S1 (refer to FIG. 2) will be explained with reference to FIG. 3. A part of the information enclosed by a frame 31 is the offer information relating to audio. A part of the information enclosed by a frame 32 is the offer information relating to video. In FIG. 3, audio-related media information “PCMU,” “G722” and “speex” are stored as the offer information. Video-related media information “H263” and “H264” are stored as the offer information. The media information indicates audio and video codecs that can be used by the communication device 12.

As shown in FIG. 2, the communication device 13 receives, via the server 11, the request packet (INVITE) transmitted from the communication device 12 (step S2). It is assumed that an input operation is performed on the communication device 13 to permit the start of the video conference with the communication device 12. Of the offer information stored in the request packet (INVITE), the communication device 13 selects at least one of the media information of the media that can be used by the communication device 13. The selected media information is stored in the RAM 23 as the media information of the media to be used in a session with the communication device 12. The selected media information is stored in a positive response packet (OK response) that notifies permission to establish the communication path. The positive response packet (OK response) in which the media information is stored is transmitted to the communication device 12 via the server 11 (step S3). Hereinafter, media information that is selected from media information included in offer information and that is stored in a packet is referred to as “answer information.”

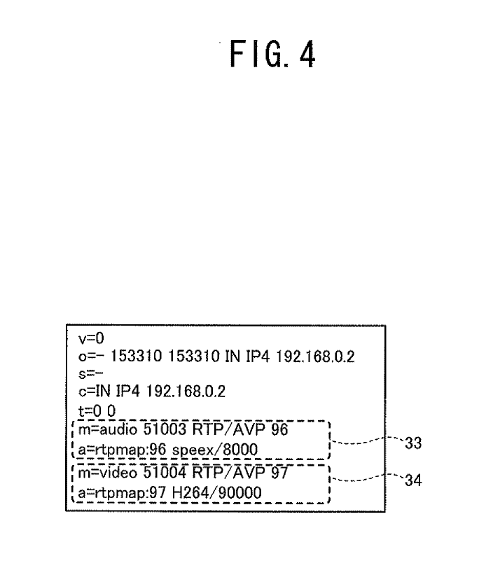

The information stored in the positive response packet (OK response) transmitted at step S3 (refer to FIG. 2) will be explained with reference to FIG. 4. A part of the information enclosed by a frame 33 is the answer information relating to audio. A part of the information enclosed by a frame 34 is the answer information relating to video. In FIG. 4, the audio-related media information “speex” is stored as the answer information. The video-related media information “H264” is stored as the answer information. The media information indicates the audio and video codecs specified to be used when performing the session between the communication devices 12 and 13.

As shown in FIG. 2, the communication device 12 receives, via the server 11, the positive response packet (OK response) transmitted from the communication device 13 (step S4). The communication device 12 extracts the media information from the answer information stored in the positive response packet (OK response), and stores the extracted media information in the RAM 23 as the media information of the media to be used in the session. As notification that the positive response packet (OK response) has been received, the communication device 12 transmits an ACK packet to the communication device 13 via the server 11 (step S5). The communication device 13 receives the ACK packet via the server 11 (step S6).

Through the above-described call control communication, the communication devices 12 and 13 can identify the media to be used in the session. The communication path is established between the communication devices 12 and 13. Then the communication devices 12 and 13 can perform P2P communication without performing communication via the server 11. The video conference is performed by performing the session between the communication devices 12 and 13 (step S7). The communication devices 12 and 13 perform the session using the media identified by the media information stored in the RAM 23.

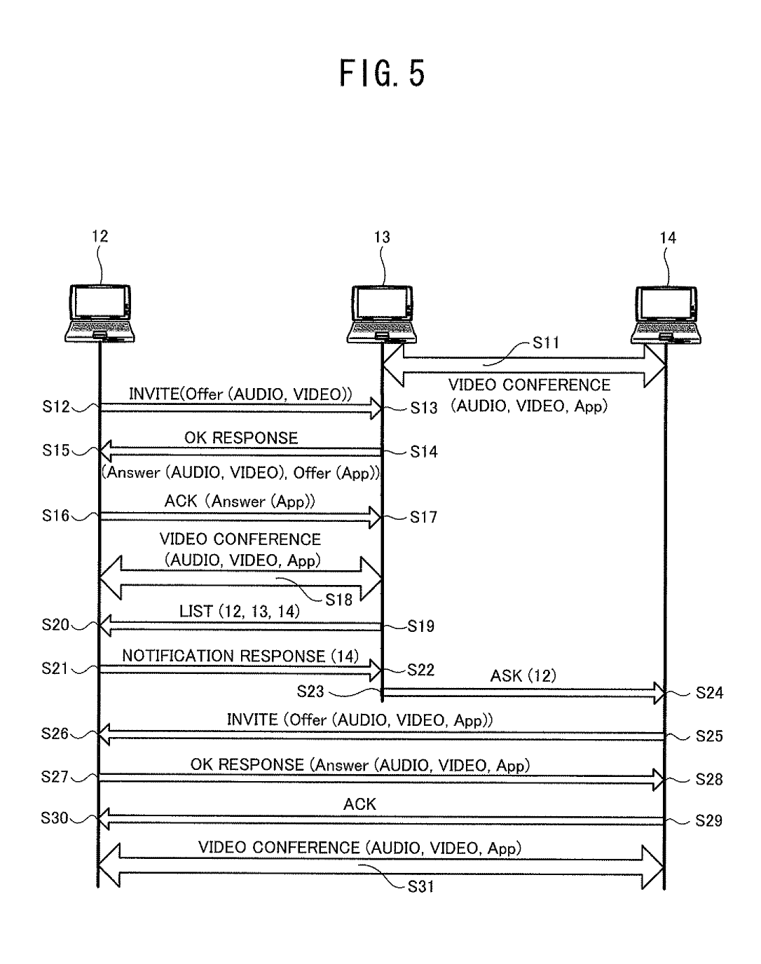

Another example of call control communication based on the SDP will be explained with reference to FIG. 5. Similarly to FIG. 2, the server 11 is not shown in FIG. 5. In FIG. 5, a communication path between the communication devices 13 and 14 is already established, and the video conference is being performed (step S11). In this session, audio and video codecs, and a dedicated application that is used when performing the video conference, are used as the media. Hereinafter, the dedicated application that is used when the video conference is being performed is also referred to as “App.” The communication devices 13 and 14 use these media to perform the session and thus perform the video conference.

It is assumed that an input operation is performed on the communication device 12 to start the video conference with the communication device 13. The communication device 12 transmits a request packet (INVITE) to the communication device 13 (step S12). The offer information shown in FIG. 3 is stored in the request packet (INVITE). The communication device 13 receives the request packet (INVITE) (step S13). Based on the media information that is stored as the offer information in the received request packet (INVITE), the communication device 13 identifies the media information to be stored in a positive response packet (OK response) as answer information.

In a known method, from among the media information stored as the offer information, the communication device 13 selects at least one of the media information as the media information to be stored as the answer information. The media information relating to the dedicated application is not stored as the offer information in the request packet (INVITE), and therefore the media information relating to the dedicated application is not selected as the media information to be stored as the answer information in the positive response packet (OK response). In this case, even if the answer information is notified to the communication device 12, the communication device 12 cannot recognize a necessity for the dedicated application. To address this, in the present embodiment, from among the media information (audio, video) stored as the offer information in the request packet (INVITE), the communication device 13 selects at least one of the media information as the media information to be stored as the answer information in the positive response packet (OK response). At the same time, the communication device 13 also identifies the media information of the dedicated application being used to perform the video conference as media information to be stored as offer information in the positive response packet (OK response). The offer information is stored with the answer information in the positive response packet (OK response) and transmitted to the communication device 12 (step S14).

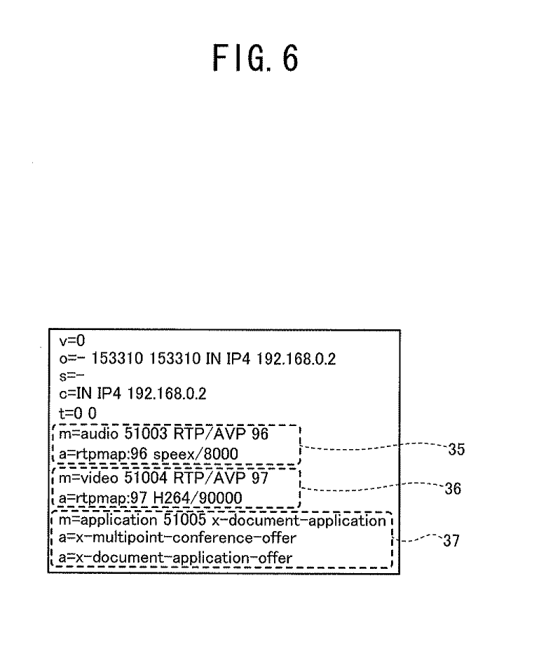

The information stored in the positive response packet (OK response) transmitted at step S14 (refer to FIG. 5) will be explained with reference to FIG. 6. A part of the information enclosed by a frame 35 is the answer information relating to audio. A part of the information enclosed by a frame 36 is the answer information relating to video. A part of the information enclosed by a frame 37 is the offer information relating to the dedicated application. In FIG. 6, dedicated application-related media information “x-multipoint-conference” and “x-document-application” are stored as the offer information. “x-multipoint-conference” is an application to perform the video conference. “x-document-application” is an application for file sharing. These pieces of information indicate the media information relating to the dedicated application necessary when performing the session between the communication devices 13 and 14.

As shown in FIG. 5, the communication device 12 receives the positive response packet (OK response) (step S15). The communication device 12 extracts the media information from the answer information stored in the positive response packet (OK response), and stores the extracted media information in the RAM 23 as the media information of the media to be used in the session with the communication device 13. Of the media information stored as the offer information in the positive response packet (OK response), the communication device 12 selects at least one of the media information which is the media information of the media that can be used by the communication device 12 and that is specified to be used in the session with the communication device 13. The selected media information is stored in the RAM 23 as the media information of the media to be used in the session with the communication device 13. The selected media information is stored in an ACK packet as answer information. The ACK packet is transmitted to the communication device 13 (step S16).

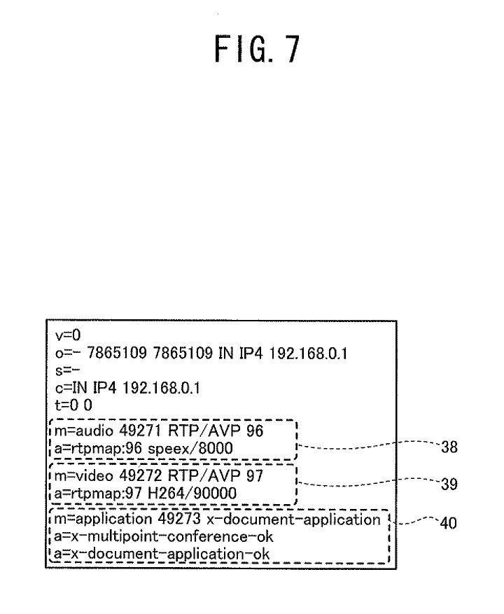

The information stored in the ACK packet will be explained with reference to FIG. 7. A part of the information enclosed by a frame 38 is the answer information relating to audio. A part of the information enclosed by a frame 39 is the answer information relating to video. These pieces of answer information are taken without change from the answer information (refer to the frame 35 and the frame 36 in FIG. 6) that is stored in the positive response packet (OK response) received by the communication device 12 at step S15. A part of the information enclosed by a frame 40 is the answer information relating to the dedicated application. In FIG. 7, the dedicated application-related media information “x-multipoint-conference” and “x-document-application” are stored as the answer information. Both these pieces of information are the media information of the media necessary to perform the video conference between the communication devices 12 and 13. The communication device 12 selects both the pieces of media information of the dedicated applications and stores them as answer information in an ACK packet.

As shown in FIG. 5, the communication device 13 receives the ACK packet (step S17). The communication device 13 extracts the media information from the answer information stored in the ACK packet and stores it in the RAM 23 as the media information of the media to be used in the session. Through the above-described call control communication, the communication path is established between the communication devices 12 and 13. Then the communication devices 12 and 13 can perform P2P communication. The video conference is performed by performing the session between the communication devices 12 and 13 (step S18). The communication devices 12 and 13 perform the session using the media (the audio and video codecs and the dedicated application) identified by the media information stored in the RAM 23.

In the above-described manner, in a case where the communication path is already established between the communication devices 13 and 14 when the communication device 13 receives the request packet (INVITE) from the communication device 12, the communication device 13 determines whether or not media particular to the established communication path are being used. When the particular media are being used in the already established communication path, the communication device 13 stores offer information in a positive response packet (OK response), in order to notify the communication device 12 of the media information of the particular media. In this way, the communication device 13 notifies the communication device 12 of new media information and it is thus possible to smoothly establish the communication path between the communication devices 12 and 13.

After the communication device 13 has started the video conference with the communication device 12, the communication device 13 performs processing to establish a communication path between the communication devices 12 and 14. The communication device 13 transmits a list packet to the communication device 12 (step S19). The list packet is a packet to notify the communication device 12 of the existence of the communication device 14 that is performing the video conference with the communication device 13. IDs for all the communication devices 12, 13 and 14 that are currently participating in the video conference are stored in the list packet.

The communication device 12 receives the list packet transmitted from the communication device 13 (step S20). The communication device 12 extracts the IDs stored in the list packet. From among the communication devices 12, 13 and 14 identified by the extracted IDs, the communication device 12 selects the ID (14) of the communication device 14 that is not currently performing a video conference with the communication device 12. The communication device 12 generates a notification response packet as notification of the selected ID (14). The communication device 12 transmits the generated notification response packet to the communication device 13 (step S21). The communication device 13 receives the notification response packet (step S22).

The communication device 13 extracts the ID (14) stored in the received notification response packet. The communication device 13 recognizes that a communication path has not been established between the communication device 12 that has transmitted the notification response packet and the communication device 14 that is identified by the extracted ID (14). The communication device 13 performs processing to establish a communication path between the communication devices 12 and 14. The communication device 13 transmits to the communication device 14 an ask packet that asks the communication device 14 to transmit a request packet (INVITE) to the communication device 12 (step S23). The ID (12) of the communication device 12 is stored in the ask packet. The communication device 14 receives the ask packet (step S24).

Based on the ID (12) stored in the ask packet, the communication device 14 identifies the communication device 12 as the destination of the request packet (INVITE). In order to establish a communication path with the communication device 12, the communication device 14 transmits the request packet (INVITE) to the communication device 12 via the server 11 (step S25). Media information of the media that can be used by the communication device 14 (audio, video and dedicated application) is stored in the request packet (INVITE) as offer information. The communication device 12 receives the request packet (INVITE) via the server 11 (step S26).

It is assumed that an input operation is performed on the communication device 12 to permit the video conference with the communication device 14. From among the media information stored in the request packet (INVITE) as the offer information, the communication device 12 selects the media information to be stored as answer information in a positive response packet (OK response). The selected media information is stored in the RAM 23. The positive response packet (OK response), in which the selected media information is stored as the answer information, is transmitted to the communication device 14 via the server 11 (step S27). The communication device 14 receives the positive response packet (OK response) via the server 11 (step S28). The communication device 14 extracts the answer information stored in the positive response packet (OK response) and stores the extracted answer information in the RAM 23 as the media information of the media to be used in the session. The communication device 14 transmits an ACK packet to the communication device 12 via the server 11 (step S29). The communication device 12 receives the ACK packet via the server 11 (step S30).

Through the above-described call control communication, the communication path is established between the communication devices 12 and 14. Then the communication devices 12 and 14 can perform P2P communication without performing communication via the server 11. The video conference is performed between the communication devices 12 and 14 (step S31).

In the above-described manner, when the communication device 13 receives the request packet (INVITE) from the communication device 12 in the state in which the communication path is already established between the communication devices 13 and 14, the communication device 13 first establishes the communication path with the communication device 12. Next, the communication device 13 performs the processing to establish the communication path between the communication devices 12 and 14. In this way, the communication device 13 can reliably establish the communication path between the communication device 14, which is already participating in the video conference, and the communication device 12, which is newly entering the video conference. By thus transmitting the request packet (INVITE) to one of other communication devices 2 that are already participating in a video conference, the communication device 2 that is newly entering the video conference can establish the communication path with all of the communication devices 2 that are participating in the video conference. The communication device 2 can easily enter the video conference that is already underway.

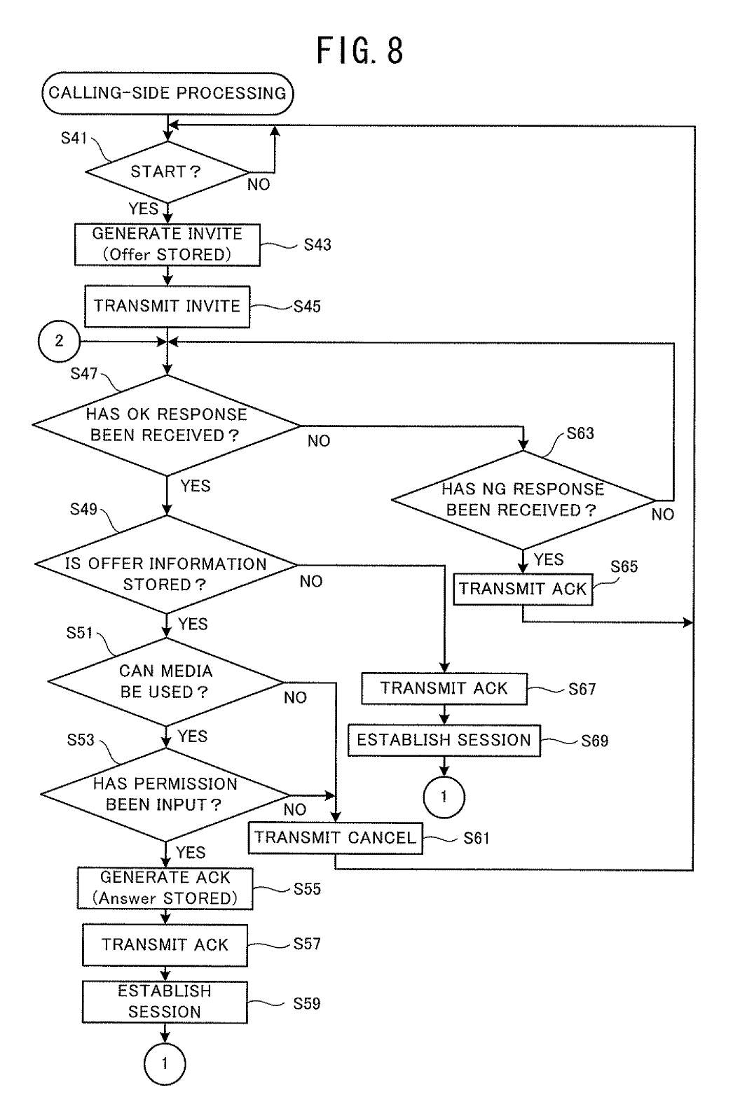

Calling-side processing and called-side processing that is performed by the CPU 21 of the communication device 2 will be explained with reference to FIG. 8 to FIG. 10. When a power supply of the CPU 21 is switched on, the communication program stored in the HDD 24 is activated by the CPU 21 and each of the calling-side and the called-side processes are performed by the CPU 21 in accordance with the communication program. Switching between each of the processes is performed as appropriate by the OS. In this way, each of the processes is performed individually and in parallel.

The calling-side processing will be explained with reference to FIG. 8. Step S41 to step S69 in FIG. 8 correspond to the processing at step S12 to step S18 performed by the CPU 21 of the communication device 12, as shown in FIG. 5. It is determined whether or not an input operation has been performed by a user in order to start a video conference with another one of the communication devices 2 with which a communication path is not established (step S41). The other of the communication devices 2 corresponds to the communication device 13 shown in FIG. 5. Hereinafter, the other of the communication devices 2 (with which the communication path is not established) is referred to as “partner device.” When the input operation to start the video conference has not been performed (no at step S41), the processing returns to step S41. When the input operation to start the video conference has been performed (yes at step S41), a request packet (INVITE) is generated in which offer information is stored (step S43). Here, the offer information is media information of media that can be used by the communication device 2 in a session with the partner device and is media information of the media that is specified to be used in the session. Examples of the categories of the media are audio and video. The generated request packet (INVITE) is transmitted via the server 11 to the partner device (step S45).

A determination is made as to whether or not a positive response packet (OK response), which is transmitted from the partner device in response to the request packet (INVITE), has been received via the server 11 (step S47). In a case where the positive response packet (OK response) has not been received (no at step S47), a determination is made as to whether or not a negative response packet (NG response), which rejects establishment of the communication path, has been received via the server 11 (step S63). In a case where the negative response packet (NG response) has been received (yes at step S63), this indicates that the partner device rejects establishment of the communication path. An ACK packet, which acknowledges that the negative response packet (NG response) has been received, is transmitted to the partner device via the server 11 (step S65). The communication path is not established and the processing returns to step S41. In a case where the negative response packet (NG response) has not been received (no at step S63), the processing returns to step S47.

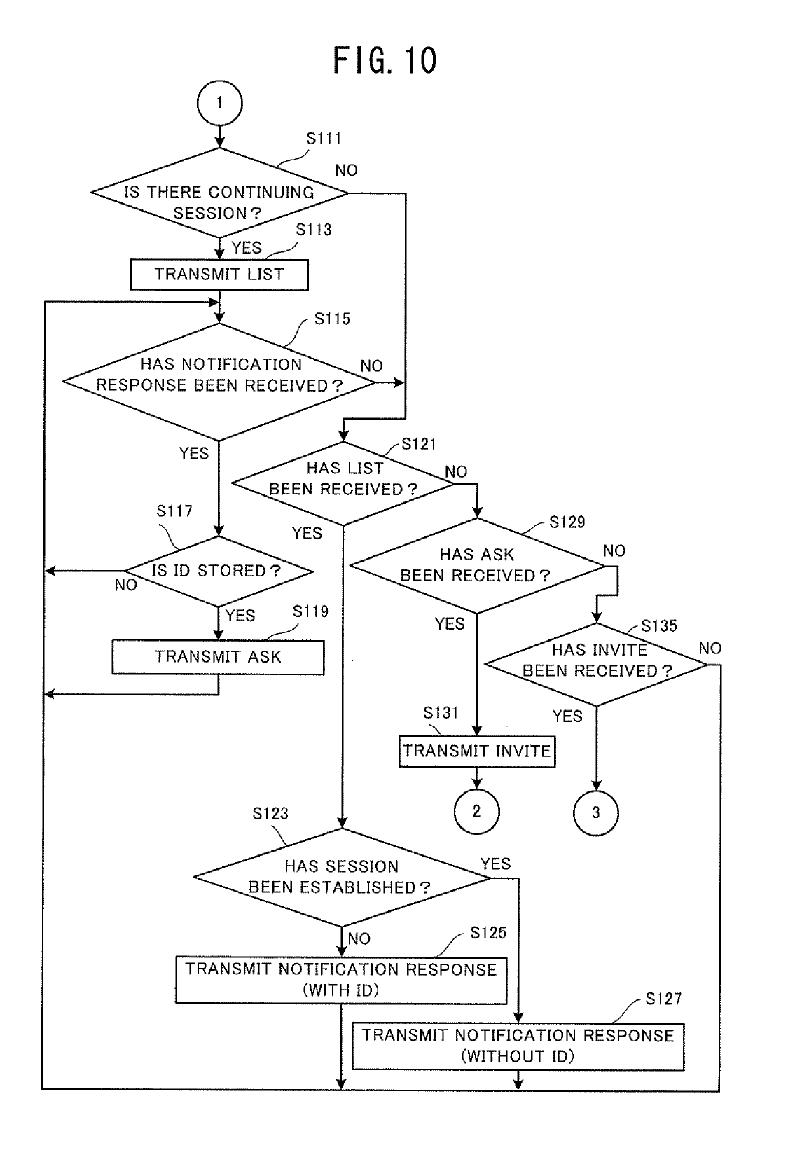

In a case where the positive response packet (OK response) returned from the partner device has been received (yes at step S47), this indicates that the partner device permits establishment of the communication path. Media information is extracted from the answer information stored in the received positive response packet (OK response) and is stored in the RAM 23. A determination is made as to whether or not the offer information is stored in the received positive response packet (OK response) (step S49). In a case where the offer information is not stored in the positive response packet (OK response) (no at step S49), the session can be performed with the partner device using the media information stored in the RAM 23. An ACK packet, which acknowledges that the positive response packet (OK response) has been received, is transmitted to the partner device via the server 11 (step S67). The communication path is established with the partner device (step S69). It becomes possible to perform P2P communication with the partner device without performing communication via the server 11. The session is started with the partner device and the video conference is performed. The media identified by the media information stored in the RAM 23 is used when performing the session. The processing advances to step S111 (refer to FIG. 10). An explanation of FIG. 10 will be made later.

On the other hand, in a case where the offer information is stored in the received positive response packet (OK response) (yes at step S49), it is possible that the partner device has already established a communication path with another of the communication devices 2. It is also possible that particular media are being used in the established communication path. A determination is made as to whether it is possible to use the media identified by the media information extracted from the offer information (step S51). In a case where none of the media identified by the extracted media information can be used (no at step S51), it is not possible for the calling-side communication device 2 to enter the already established communication path. A CANCEL packet, which notifies an end to the call control communication, is transmitted to the partner device via the server 11 (step S61). The processing returns to step S41.

In a case where at least one of the media identified by the extracted media information can be used (yes at step S51), a determination is made as to whether an input operation has been performed by the user to permit establishment of the communication path with the partner device (step S53). In a case where the input operation to permit establishment of the communication path is not performed within a predetermined period of time or when an input operation is performed by the user to reject establishment of the communication path (no at step S53), a CANCEL packet to end the call control communication is transmitted to the partner device via the server 11 (step S61). The processing returns to step S41.

In a case where the input operation has been performed to permit the establishment of the communication path with the partner device (yes at step S53), the media information extracted from the offer information stored in the positive response packet (OK response) received at step S47 is referred to. From among the media identified by the extracted media information, at least one of the media, which can be used and which is specified by the media information to be used in the session with the partner device, is selected from the extracted media information. The media information of the selected media is stored as answer information in an ACK packet that acknowledges that the positive response packet (OK response) has been received. The ACK packet is generated in this way (step S55). The generated ACK packet is transmitted to the partner device via the server 11 (step S57). The media information of the selected media is stored in the RAM 23. Through the above-described processing, the communication path is established with the partner device (step S59). It becomes possible to perform P2P communication with the partner device without performing communication via the server 11. The session with the partner device is started and the video conference is performed. The media identified by the media information stored in the RAM 23 is used when performing the session. The processing advances to step S111 (refer to FIG. 10). FIG. 10 will be explained later.

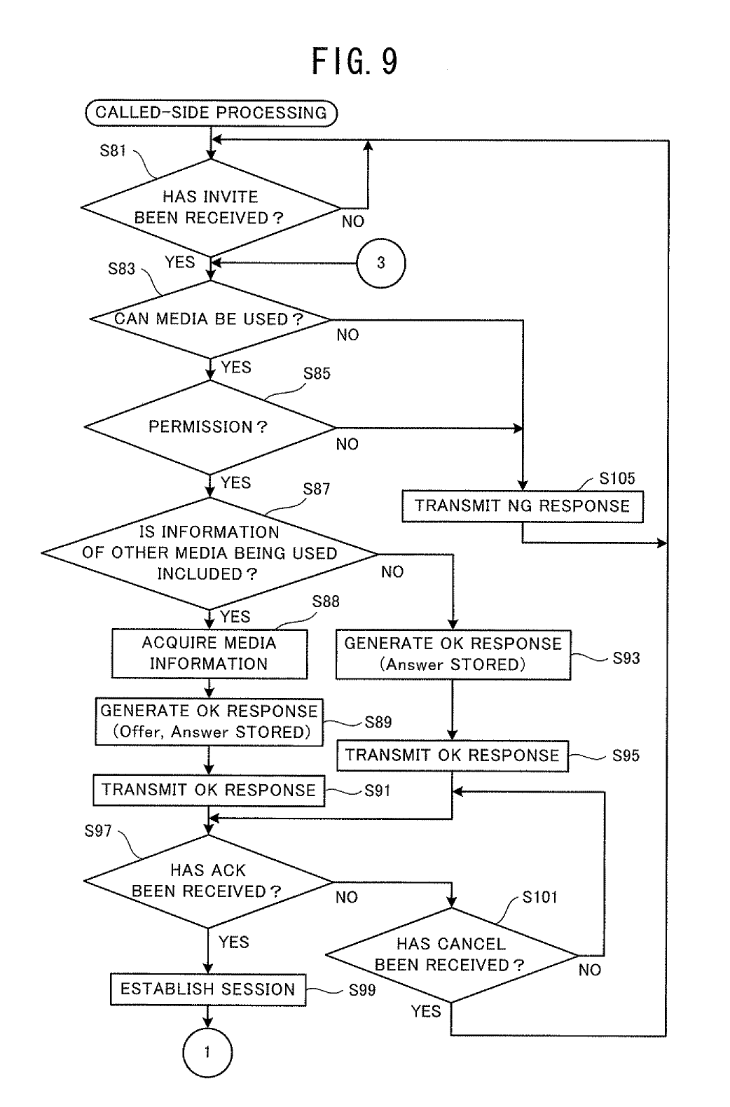

The called-side processing will be explained with reference to FIG. 9. Step S81 to step S105 in FIG. 9 correspond to the processing at step S13 to step S18 performed by the CPU 21 of the communication device 13, as shown in FIG. 5. The communication device 12 shown in FIG. 5 corresponds to the partner device. A determination is made as to whether a request packet (INVITE), which requests establishment of a communication path, has been received from the partner device via the server 11 (step S81). In a case where the request packet (INVITE) has not been received from the partner device (no at step S81), the processing returns to step S81. In a case where the request packet (INVITE) has been received from the partner device (yes at step S81), the media information is extracted from the offer information stored in the request packet (INVITE). A determination is made as to whether the media identified by the extracted media information can be used (step S83). In a case where none of the extracted media information can be used (no at step S83), this means that a communication path cannot be established with the partner device and therefore a negative response packet (NG response) is transmitted to the partner device (step S105). In this way, in a case where the communication device 2 can use none of the media identified by the extracted media information and it is not possible to establish the communication path, it is possible to reject establishment of the communication path. By doing this, the communication device 2 can inhibit the session from being established improperly. The processing returns to step S81.

In a case where at least one of the media identified by the extracted media information can be used (yes at step S83), a determination is made as to whether an input operation has been performed by a user in order to permit establishment of the communication path with the partner device (step S85). In a case where the input operation to permit the establishment of the communication path has not been performed within a predetermined period of time, or in a case where an input operation has been performed by the user to reject the establishment of the communication path (no at step S85), a negative response packet (NG response) is transmitted to the partner device via the server 11 (step S105). The processing returns to step S81.

In a case where the input operation to permit the establishment of the communication path with the partner device has been performed (yes at step S85), the media information extracted from the offer information stored in the request packet (INVITE) received at step S81 is referred to. A determination is made as to whether a communication path is already established with one of the communication devices 2 apart from the partner device, and whether the media information of the media being used in the already established communication path is all included in the extracted media information. Namely, a determination is made as to whether there is the media information of any other media that is being used (step S87). In a case where there is the media information of the media that is being used apart from the media identified by the extracted media information (yes at step S87), it is necessary to notify the partner device of the media information of the media being used. The media information of the media that is being used apart from the media identified by the extracted media information is acquired (step S88). The acquired media information is stored in a positive response packet (OK response) as offer information. Of the media information extracted from the offer information stored in the request packet (INVITE) received at step S81, at least one of the media information of the media, which can be used and which is also specified to be used in the session with the partner device, is selected. The selected media information is stored in the positive response packet (OK response) as answer information. In this way, the positive response packet (OK response) is generated in which the offer information and the answer information are stored (step S89). The generated positive response packet (OK response) is transmitted to the partner device via the server 11 (step S91). The media information stored as the answer information is stored in the RAM 23. The processing advances to step S97.

In a case where a communication path is not established with another of the communication devices 2 apart from the partner device, or in a case where the media information of the media that is being used in the established communication path is all included in the media information extracted from the offer information, namely, in a case where there is no media information of other media being used (no at step S87), it is not necessary to store the offer information in the positive response packet (OK response). Of the media information extracted from the offer information, at least one of the media information of the media that can be used and that is specified to be used in the session with the partner device is selected. The selected media information is stored in the positive response packet (OK response) as the answer information. In this way, the positive response packet (OK response) is generated in which the answer information is stored (step S93). The generated positive response packet (OK response) is transmitted to the partner device via the server 11 (step S95). The media information that is stored as the answer information is stored in the RAM 23. The processing advances to step S97.

A determination is made as to whether an ACK packet returned from the partner device in response to the positive response packet (OK response) transmitted at step S91 or at step S95 has been received via the server 11 (step S97). In a case where the ACK packet has been received (yes at step S97), the communication path is established with the partner device (step S99). It becomes possible to perform P2P communication with the partner device without performing communication via the server 11. The session with the partner device is started and the video conference is performed. The media identified by the media information that is stored in the RAM 23 is used when performing the session. The processing returns to step S111 (refer to FIG. 10). FIG. 10 will be explained later.

On the other hand, in a case where the ACK packet has not been received (no at step S97), a determination is made as to whether or not a CANCEL packet has been received (step S101). In a case where the CANCEL packet has been received (yes at step S101), the communication path is not established and the processing returns to step S81. In a case where the CANCEL packet has not been received (no at step S101), the processing returns to step S97.

A flow chart shown in FIG. 10 will be explained. Step S111 to step S135 in FIG. 10 correspond to the processing at step S19 to step S31 performed by the CPUs 21 of the communication devices 12, 13 and 14, as shown in FIG. 5. A determination is made as to whether a session with another of the communication devices 2 apart from the partner device is continuing to be performed when the communication path is established with the partner device at step S59 (refer to FIG. 8) and step S69 (refer to FIG. 8), and step S99 (refer to FIG. 9) (step S111). Hereinafter, the other communication device 2 that is continuing the session when the communication path is established with the partner device is referred to as “continuing device.” In a case where the continuing device is not present (no at step S111), the processing advances to step S121. In a case where the continuing device is present (yes at step S111), a list packet is generated in which at least an ID of the continuing device is stored. The generated list packet is transmitted to the partner device (step S113).

After the list packet is transmitted to the partner device, a determination is made as to whether a notification response packet has been received from the partner device (step S115). In a case where the notification response packet has not been received (no at step S115), the processing advances to step S121. In a case where the notification response packet has been received (yes at step S115), a determination is made as to whether an ID is stored in the notification response packet (step S117). In a case where the ID is not stored in the notification response packet (no at step S117), this indicates that a communication path is established between the partner device and the continuing device. The processing returns to step S115.

In a case where the ID is stored in the notification response packet (yes at step S117), the continuing device is present that has not established a communication path with the partner device. The ID stored in the notification response packet is extracted. In order to establish a communication path between the continuing device that is identified by the extracted ID and the partner device, an ask packet is transmitted to the continuing device identified by the extracted ID (step S119). The ID of the partner device is stored in the ask packet. In this way, the communication device 2 controls the communication such that a communication path is established between the partner device and the continuing device. The processing returns to step S115.

Meanwhile, in a case where the continuing device is not present (no at step S111) or in a case where the notification response packet in response to the list packet transmitted to the partner device has not been received (no at step S115), a determination is made as to whether the list packet has been received from the partner device (step S121). In a case where the list packet has been received (yes at step S121), IDs stored in the list packet are extracted. A determination is made as to whether a communication path has been established with the other communication devices 2 identified by the extracted IDs (step S123). In a case where the other communication device 2 is present with which a communication path has not been established (no at step S123), a notification response packet is generated by storing the ID of the other communication device 2 with which the communication path is not established in the notification response packet. The generated notification response packet is returned to the partner device that transmitted the list packet (step S125). The processing returns to step S115. In a case where communication paths are established with all of the other communication devices 2 identified by the extracted IDs (yes at step S123), a notification response packet is generated that does not include the IDs. The generated notification response packet is transmitted to the partner device that transmitted the list packet (step S127). The processing returns to step S115.

In a case where the list packet has not been received at step S121 (no at step S121), a determination is made as to whether the ask packet transmitted from the continuing device has been received (step S129). In a case where the ask packet has been received (yes at step S129), an ID stored in the ask packet is extracted. In order to establish a communication path with the other communication device 2 identified by the extracted ID, a request packet (INVITE) is transmitted (step S131). Media information being used in the session with the continuing device is stored in the request packet (INVITE) as offer information. The processing returns to step S47 (refer to FIG. 8).

In a case where the ask packet has not been received (no at step S129), a determination is made as to whether a request packet (INVITE) requesting establishment of a communication path has been received (step S135). In a case where the request packet (INVITE) has been received (yes at step S135), the processing returns to step S83 (refer to FIG. 9). In a case where the request packet (INVITE) has not been received (no at step S135), the processing returns to step S115.

Each of the processes performed by the CPUs 21 of the communication devices 12, 13 and 14 when the communication sequence shown in FIG. 5 is performed will be explained with reference to the flow charts shown in FIG. 8 to FIG. 10. When the input operation has been performed for the communication device 12 to enter the video conference with the communication device 13 (yes at step S41, (refer to FIG. 8)), the request packet (INVITE) that includes the offer information is generated (step S43, (refer to FIG. 8)) and is transmitted to the communication device 13 (step S12 (refer to FIG. 5), step S45 (refer to FIG. 8)). The communication device 13 receives the request packet (INVITE) (step S13 (refer to FIG. 5), yes at step S81 (refer to FIG. 9)). The communication device 13 extracts the media information from the offer information stored in the request packet (INVITE). It is assumed that the communication device 13 can use the media identified by the extracted media information (yes at step S83 (refer to FIG. 9)). The input operation is performed to permit establishment of the communication path (yes at step S85 (refer to FIG. 9)). The communication device 13 has established the communication path with the communication device 14 and the media that is particular to the session is used (yes at step S87 (refer to FIG. 9)), and thus the positive response packet (OK response), in which the offer information and the answer information is stored, is generated (step S89 (refer to FIG. 9)) and is transmitted to the communication device 12 (step S14 (refer to FIG. 5), step S91 (refer to FIG. 9)).

The communication device 12 receives the positive response packet (OK response) (step S15 (refer to FIG. 5), yes at step S47 (refer to FIG. 8)). The offer information is stored in the received positive response packet (OK response) (yes at step S49 (refer to FIG. 8)). It is presupposed that the communication device 12 can use the media identified by the media information extracted from the offer information (yes at step S51 (refer to FIG. 8)). When the input operation has been performed to permit the establishment of the communication path with the communication device 13 (yes at step S53 (refer to FIG. 8)), the media information of the media that can be used is extracted from the offer information and is stored in the ACK packet as the answer information (step S55 (refer to FIG. 8)). The communication device 12 transmits the ACK packet to the communication device 13 (step S16 (refer to FIG. 5), step S57 (refer to FIG. 8)). The communication device 13 receives the ACK packet (step S17 (refer to FIG. 5), yes at step S97 (refer to FIG. 9)). The communication devices 12 and 13 establish the communication path (step S18 (refer to FIG. 5), step S59 (refer to FIG. 8), step S99 (refer to FIG. 9)) and start the session.

After the session is started, as the communication device 13 is continuing the session with the communication device 14 (yes at step S111 (refer to FIG. 10), the list packet storing the IDs 12, 13 and 14 is transmitted to the communication device 12 (step S19 (refer to FIG. 5, step S113 (refer to FIG. 10)). The communication device 12 receives the list packet (step S20 (refer to FIG. 5), yes at step S121 (refer to FIG. 10)). The communication device 12 has not established a communication path with the communication device 14 (no at step S123 (refer to FIG. 10) and thus the communication device 12 transmits to the communication device 13 the notification response packet in which the ID 14 is stored (step S21 (refer to FIG. 5), step S125 (refer to FIG. 10)). The communication device 13 receives the notification response packet (step S22 (refer to FIG. 5), yes at step S115 (refer to FIG. 10)). As the ID 14 is stored in the notification response packet (yes at step S117 (refer to FIG. 10)), the communication device 13 transmits to the communication device 14 the ask packet in which is stored the ID 12 (step S23 (refer to FIG. 5), step S119 (refer to FIG. 10)).

The communication device 14 receives the ask packet (step S24 (refer to FIG. 5, yes at step S129 (refer to FIG. 10)). The communication device 14 transmits the request packet (INVITE) to the communication device 12 that is identified by the ID stored in the ask packet (step S25 (refer to FIG. 5), step S131 (refer to FIG. 10)). The offer information is stored in the request packet (INVITE). The communication device 12 receives the request packet (INVITE) (step S26 (refer to FIG. 5), yes at step S135 (refer to FIG. 10)). When the communication device 12 determines, based on the offer information, that the communication path can be established, the communication device 12 transmits the positive response packet (OK response) to the communication device 14 (step S27 (refer to FIG. 5), step S91 (refer to FIG. 9)). The communication device 14 receives the positive response packet (OK response) (step S28 (refer to FIG. 5), yes at step S47 (refer to FIG. 8)). The communication device 14 transmits the ACK packet to the communication device 12 (step S29 (refer to FIG. 5), step S57 (refer to FIG. 8)). The communication device 12 receives the ACK packet (step S30 (refer to FIG. 5), yes at step S97 (refer to FIG. 9)). The communication devices 12 and 14 start the session (step S31 (refer to FIG. 5), step S59 (refer to FIG. 8), step S99 (refer to FIG. 9)).

As described above, the communication device 2 can store the media information of the media being used in the session with the continuing device in the positive response packet (OK response) that is in response to the request packet (INVITE), and can transmit the positive response packet (OK response) to the partner device that transmitted the request packet (INVITE). The communication device 2 can newly establish the communication path with the partner device using the same conditions as the session that is underway, and it is thus possible to smoothly establish the communication path and start P2P communication.

By transmitting the request packet (INVITE) to one of the plurality of other communication devices 2 that have mutually established a communication path, the communication device 2 can establish a communication path with the remaining other communication device 2. It is not necessary for the communication device 2 to transmit the request packet (INVITE) to all the plurality of other communication devices 2 that have mutually established the communication path. Therefore, the communication device 2 can easily and rapidly establish communication paths with the plurality of other communication devices 2 and start P2P communication.

In a case where the communication device 2 can use the media identified by the media information stored as the offer information in the request packet (INVITE), the communication device 2 can establish the communication path with the partner device that transmitted the request packet (INVITE). The communication device 2 can reliably establish the communication path with the partner device that transmitted the request packet (INVITE).

It should be noted that the present disclosure is not limited to the above-described embodiment, and various modifications are possible. In the communication sequence shown in FIG. 5, after the communication path has been established between the communication devices 12 and 13 (step S18 (refer to FIG. 5)), the communication device 13 transmits the list packet to the communication device 12 (step S19 (refer to FIG. 5)) and thus the communication device 13 ascertains a status of the establishment of the communication path with the communication device 12. Alternatively the communication device 13 may store ID information of the other communication device 2 (the communication device 14 in FIG. 5) with which it has established the communication path in the positive response packet (OK response) (step S14 (refer to FIG. 5)) that is returned in response to the request packet (INVITE) transmitted from the communication device 12. By receiving the positive response packet (OK response), the communication device 12 can ascertain a communication path establishment status of the communication device 13. In this way, it is possible to establish the communication paths between the communication device 12 and the communication devices 13 and 14 in an even shorter period of time.

In the communication sequence shown in FIG. 5, when the communication device 13 transmits the list packet to the communication device 12 (step S19 (refer to FIG. 5)), address information of the communication devices 12, 13 and 14 may also be transmitted. By referring to the address information stored in the list packet received from the communication device 13, the communication device 12 may transmit a request packet (INVITE) to the communication device 14.

In the communication sequence shown in FIG. 5, in a case where the other communication device 2 is present in a state in which a communication path is established, the communication device 12 may store, in the request packet (INVITE) that the communication device 12 transmits at step S12, the ID of the other communication device 2 for which the session is underway. In this way, the communication device 13 can transmit the ask packet to the communication device 14 at an early timing, and thus the time to establish the communication path between the communication devices 2 can be further shortened.

At step S14 of the communication sequence shown in FIG. 5, the communication device 13 may store the media information of the plurality of media being used in the session with the communication device 14, as the offer information, in the positive response packet (OK response), and transmit the positive response packet (OK response) to the communication device 12. Of the plurality of media information extracted from the offer information the communication device 12 may select at least one of the media information that can be used and that also identifies the media that is specified for use in the session with the communication device 14. Then, the selected media information may be stored as the answer information in the ACK packet and transmitted to the communication device 13.

In the communication sequence shown in FIG. 5, the offer information and the answer information need not be included in the request packet (INVITE) (step S25 (refer to FIG. 5) that is transmitted by the communication device 14 that has received the ask packet. The communication device 12 may establish the communication path with the communication device 14 by using the media that is being used in the session with the communication device 13.

The communication that is performed in the state in which the communication path is established is not limited to P2P communication, but may be communication performed via a multipoint control unit (MCU).

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A communication device comprising:
an acquisition portion that acquires a first condition in a case where a request packet requesting establishment of a communication path is received from a second communication device in a state in which a communication path with a first communication device is established, the first condition being a condition that is used to perform a session with the first communication device, the first communication device being another communication device that has established the communication path with the communication device, the second communication device being yet another communication device that has not established a communication path with the communication device;
a first transmission portion that transmits to the second communication device a response packet including the first condition acquired by the acquisition portion; and
an establishment portion that, in a case where a notification packet is received from the second communication device in response to the response packet transmitted by the first transmission portion, establishes a communication path with the second communication device to perform the session with the second communication device using the first condition, the notification packet notifying that the second communication device can perform the session by using the first condition.

2. The communication device according to claim 1, further comprising:
a second transmission portion that, in a case where the notification packet is received from the second communication device, transmits to the first communication device an ask packet that asks that the request packet be transmitted to the second communication device.

3. The communication device according to claim 1, further comprising:
a determination portion that, in a case where the request packet including a second condition is received, determines whether a session using the second condition can be performed, based on a condition that can be used when the communication device performs a session, the second condition being a condition that the second communication device can use when the second communication device performs a session;
wherein the first transmission portion transmits the response packet in a case where it is determined by the determination portion that the session can be performed using the second condition.

4. The communication device according to claim 3, further comprising:
a third transmission portion that, in a case where it is determined by the determination portion that the session cannot be performed using the second condition, transmits to the second communication device a rejection packet that rejects establishment of the communication path.

5. The communication device according to claim 1, wherein
in a case where a plurality of the first conditions are acquired by the acquisition portion, the first transmission portion transmits the response packet including the plurality of first conditions, and
in a case where the notification packet including at least one of the plurality of first conditions is received, the establishment portion establishes the communication path with the second communication device to perform the session with the second communication device using the at least one first condition included in the notification packet.

6. A communication system comprising:
a first communication device;
a second communication device; and
a third communication device;
wherein
the first communication device includes
an acquisition portion that acquires a first condition in a case where a request packet requesting establishment of a communication path is received from the third communication device in a state in which a communication path with the second communication device is established and a communication path with the third communication device is not established, the first condition being a condition that is used to perform a session with the second communication device,
a first transmission portion that transmits a response packet including the first condition acquired by the acquisition portion to the third communication device, and
a first establishment portion that, in a case where a notification packet is received from the third communication device in response to the response packet transmitted by the first transmission portion, establishes a communication path with the third communication device to perform the session with the third communication device using the first condition, the notification packet notifying that the third communication device can perform the session by using the first condition, and
the third communication device includes
a second transmission portion that transmits the request packet to the first communication device,
a first determination portion that, in a case where the response packet returned from the first communication device is received in response to the request packet transmitted by the second transmission portion, determines whether the session can be performed using the first condition included in the response packet,
a third transmission portion that, in a case where it is determined by the first determination portion that the session can be performed using the first condition, transmits the notification packet to the first communication device, and
a second establishment portion that, after the notification packet is transmitted by the third transmission portion, establishes the communication path with the first communication device to perform the session with the first communication device using the first condition.

7. The communication system according to claim 6, wherein
the first communication device further includes
a fourth transmission portion that, in a case where the notification packet is received from the third communication device, transmits to the second communication device an ask packet that asks that the request packet be transmitted to the third communication device, and
the second communication device includes
a fifth transmission portion that transmits the request packet to the third communication device in a case where the ask packet is received from the first communication device.

8. The communication system according to claim 6, wherein
the first communication device further includes
a second determination portion that, in a case where the request packet including a second condition is received from the third communication device, determines whether the session using the second condition can be performed, based on a condition that can be used when the first communication device performs a session, the second condition being a condition that the third communication device can use when the third communication device performs a session,
the first transmission portion transmits the response packet in a case where it is determined by the second determination portion that the session can be performed using the second condition, and
the second transmission portion transmits the request packet including the second condition to the first communication device.

9. The communication system according to claim 8, wherein
the first communication device further includes
a sixth transmission portion that, in a case where it is determined by the second determination portion that the session cannot be performed using the second condition, transmits a rejection packet that rejects establishment of the communication path to the third communication device.

10. The communication system according to claim 6, wherein
in a case where a plurality of the first conditions are acquired by the acquisition portion, the first transmission portion transmits the response packet including the plurality of first conditions,
in a case where the response packet including the plurality of first conditions is received from the first communication device, the third transmission portion transmits to the first communication device the notification packet that includes at least one of the plurality of first conditions, and
in a case where the notification packet including at least one of the plurality of first conditions is received, the first establishment portion establishes the communication path with the third communication device to perform the session with the third communication device using the at least one first condition included in the notification packet.

11. A computer program product stored on a non-transitory computer-readable medium, comprising instructions for causing a processor of a communication device to execute the steps of:
acquiring a first condition in a case where a request packet requesting establishment of a communication path is received from a second communication device in a state in which a communication path with a first communication device is established, the first condition being a condition that is used to perform a session with the first communication device, the first communication device being another communication device that has established the communication path with the communication device, the second communication device being yet another communication device that has not established a communication path with the communication device;
transmitting a response packet including the acquired first condition to the second communication device; and
establishing a communication path with the second communication device to perform the session with the second communication device using the first condition, in a case where a notification packet is received from the second communication device in response to the transmitted response packet, the notification packet notifying that the second communication device can perform the session by using the first condition.

12. The computer program product according to claim 11, further comprising instructions for causing a processor to execute the step of:
transmitting to the first communication device an ask packet that asks that the request packet be transmitted to the second communication device in a case where the notification packet is received from the second communication device.

13. The computer program product according to claim 11, further comprising instructions for causing a processor to execute the steps of:
determining, in a case where the request packet including a second condition is received from the second communication device, whether a session can be performed using the second condition, based on a condition that can be used when the communication device performs a session, the second condition being a condition that the second communication device can use when the second communication device performs a session, and
transmitting the response packet to the second communication device in a case where it is determined that the session can be performed using the second condition.

14. The computer program product according to claim 13, further comprising instructions for causing a processor to execute the step of:
transmitting to the second communication device a rejection packet that rejects establishment of a communication path, in a case where it is determined that the session cannot be performed using the second condition.

15. The computer program product according to claim 11, wherein
in a case where a plurality of the first conditions are acquired, the response packet including the plurality of first conditions is transmitted, and
in a case where the notification packet including at least one of the plurality of first conditions is received, a communication path is established with the second communication device to perform the session with the second communication device using the at least one first condition included in the notification packet.
